(19) United States
(12) Patent Application Publication
(10) Pub. No.: US 2002/0049798 A1
(43) Pub. Date: Apr. 25, 2002

(54) Adder-saving implementation of digital interpolation/decimation fir filter

(76) Inventors: Minsheng Wang, Plano, TX (US); Jeanne K. Pitz, Richardson, TX (US)

Correspondence Address: TEXAS INSTRUMENTS INCORPORATED, P O BOX 655474, M/S 3999, DALLAS, TX, 75265

(21) Appl. No.: 09/975,697

(22) Filed: Oct. 10, 2001

Related U.S. Application Data
(60) Provisional application No. 60/242,453, filed on Oct. 24, 2000.

(51) Int. Cl. G06F 17/10

(52) U.S. Cl. 708/319

(57) ABSTRACT

A digital filter having a first plurality of delay components connectable in series and having an input and an output and a second plurality of delay components connectable in series and having an input and said output. A system input is coupled to each of the inputs of the first and second pluralities of delay components. A plurality of adders is provided, each adder couplable alternately to a different delay component of the first plurality of delay components and then to a different delay component of the second plurality of delay components. The number of delay components of the second plurality of delay components is equal in number to the first plurality of delay components. The system input can be concurrently coupled to each of the inputs of the first and second pluralities of delay components. In accordance with a first embodiment of the invention, the number of adders is equal to one less than the number of delay components in first or second pluralities of delay components. In accordance with a second embodiment of the invention, the number of adder is equal to the number of delay components in the first or second pluralities of delay components. The digital filter is preferably a FIR

### BACKGROUND OF THE INVENTION

1. Field of the Invention

This invention relates generally to digital filters and, more particularly, to a novel architecture for a finite impulse response (FIR) filter.

2. Brief Description of the Prior Art

Digital filters are well known in the prior art. Such filters receive sampled digital signals and transmit a sampled waveform therethrough. The waveform transmitted by the digital filter is determined by coefficients operating on portions of the transmitted digital signal. A typical prior art digital filter has a plurality of serially connected delay components with an output of each delay component transmitted to a coefficient addition component, the coefficient addition component adding the output from the delay component applied thereto by a weighting factor derived from a transform function. The outputs of the coefficient addition components are applied to the input of a succeeding delay element and eventually provide the filter output signal. Accordingly, an input signal, after an appropriate delay, is filtered according to the coefficient addition components with the resulting signal being applied to the digital filter output.

A typical prior art FIR filter is shown in FIG. 1 which shows the register-level implementation diagram for a seven-tap FIR filter which operates in accordance with the equation:

H(z)=b₁z⁻¹+b₂z⁻²+b₃z⁻³+b₄z⁻⁴+b₅z⁻⁵+b₆z⁻⁶+b₇z⁻⁷

where H(z)=Y(z)/X(z) is the transfer function of the system. For a linear-phase response, the coefficients must be symmetric with respect to the center tap with z-⁻¹ representing a register unit (such as a D flip-flop) to store the result of the previous calculation. The input data x(n) can be interpolated by, for example, 2 before filtering in the present example, though this number is arbitrary. Interpolation by M means that M−1 zeros are inserted between adjacent input samples. On the other hand, decimation by M means that every M−1 input samples are dropped. Digital filters which perform these functions are known as interpolation/decimation filters. The interpolation/decimation filters are commonly used in modern digital communication and audio systems. Assuming that the input data rate is clk, then the clock rate for the FIR filter in FIG. 1 has to be twice clk due to the interpolation at the front or at the filter input.

The equation for any FIR filter H(z) can be decomposed into Z⁻¹H₀(z)+H₁(z) where:

H₀(z)=b₁+b₃z⁻²+b₅z⁻⁴+b₇z⁻⁶

and

H₁(z)=b₂z⁻²+b₄z⁻⁴+b₆z⁻⁶.

Therefore, the system of FIG. 1 can be upgraded into a system as shown in FIG. 2 which includes two serially connected sets of delay elements (e.g. D flip-flops), each delay element except the first is preceded by an adder which adds in one of the coefficients. One set of delay elements includes a first delay element which receives the input x(n) and multiplies the input by the coefficient b₇ at a first delay, the output of which is added to the input multiplied by the coefficient b₅ and delayed with the output of that delay being added to the input multiplied by the coefficient the b₃ and being delayed, the output thereof being added to the input multiplied by the coefficient b₁ and being delayed with the output of the final delay being multiplexed with the output of the other set of delay elements to provide the output Yn of the filter. The second set of delay elements also receives the input x(n) and multiplies the input by the coefficient b₆ at a first delay, the output of which is added to the input multiplied by the coefficient b₄ and delayed with the output of the delay being added to the input multiplied by the coefficient b₂ and delayed with the output of that delay being added to zero and delayed to the output for multiplexing as discussed above. It can be seen that the input x(n) is applied to both sets of delay elements with the outputs of the two sets of delay elements being multiplexed to provide output y(n).

The advantage of the system of FIG. 2 over that of FIG. 1 is that the clock rate of the filter is the same as the input data rate clk, which is half of the clock rate of the system of FIG. 1. However, the system of FIG. 2 has two basic disadvantages, these being (1) that the amount of hardware, including adders and registers, is no less than that in the FIG. 1 system and (2) that the multiplexer connecting the output of each set of delay elements may cause glitches in the final filter output, y(n). More specifically, there are the same number of adders and one more register used in the FIG. 2 system wherein the adder for adding zero is not actually needed, but the associated register is necessary in order to maintain the correct output. For even-order FIR filters, the number of adders and registers is the same for the FIG. 1 and FIG. 2 systems. With reference to the multiplexer, in digital design, it is desirable to obtain the output from a register rather than from combinational circuits. Placing the multiplexer within the register can resolve the glitch issue, however it will introduce more gates into the circuits, which is not desirable.

### SUMMARY OF THE INVENTION

Because the output of the Mth order FIR filter depends upon its previous M input data, the number of registers is usually no less than M. However, a number of adders can be saved (eliminated) through the resource of reuse, which is an important feature of the present invention. Since an N-bit ripple adder takes about the same number of gates as does an N-bit register, reducing the number of adders also can reduce quite significantly the silicon area of the semiconductor chip required for the filter.

The second set of delay elements of FIG. 2 is identical in structure to the first set of delay elements. Therefore, in accordance with the present invention, the adders in the first set of delay elements are reused or, in other words, these adders are used in conjunction with both the first and second set of delay elements. To this end, the filter is operated at twice the clock rate of clk. In the first half of the clk period, the output of the first set of delay elements is calculated and in the second half of the clk period, the output of the second set of delay elements is calculated. The output y(n) is the output of the last register in the first set of delay elements with no output multiplexer required. In summary, the adders of the first set of delay elements are reused by running the filter at twice the clock rate and computing H₀(z) and H₁(z) on a time-sharing basis.

The system can be further optimized by omitting two redundant registers as shown in FIG. 4. The first delay element in each set of delay elements Q₁ and Q₂ can be shared, thereby removing one of the delay elements. Also, the last delay element in each set of delay elements Q₇ and Q₈ can be shared, thereby removing another delay element. Since the delay element Q₇ stores the quantity associated with the coefficient b₇ in the first clock phase, in order to share Q₇ in the second clock phase, the corresponding coefficient needs to be adjusted by subtracting b₇ from b₆ to obtain the correct result. Multiplication of x by bᵢ is actually performed by shifts and addition of x in standard manner.

### BRIEF DESCRIPTION OF THE DRAWINGS

FIG. 1 is a diagram of a prior art FIR filter;

FIG. 2 is a diagram of an upgraded FIR filter in accordance with the prior art;

FIG. 3 is a diagram of an FIR filter in accordance with a first embodiment of the present invention;

FIG. 4a is a diagram of an FIR filter in accordance with a second embodiment of the present invention;

FIG. 4b is a block diagram of an FIR filter in accordance with a second embodiment of the present invention; and

FIG. 5 is a timing diagram for use in conjunction with the FIR filter of FIG. 4b.

### DESCRIPTION OF THE PREFERRED EMBODIMENT

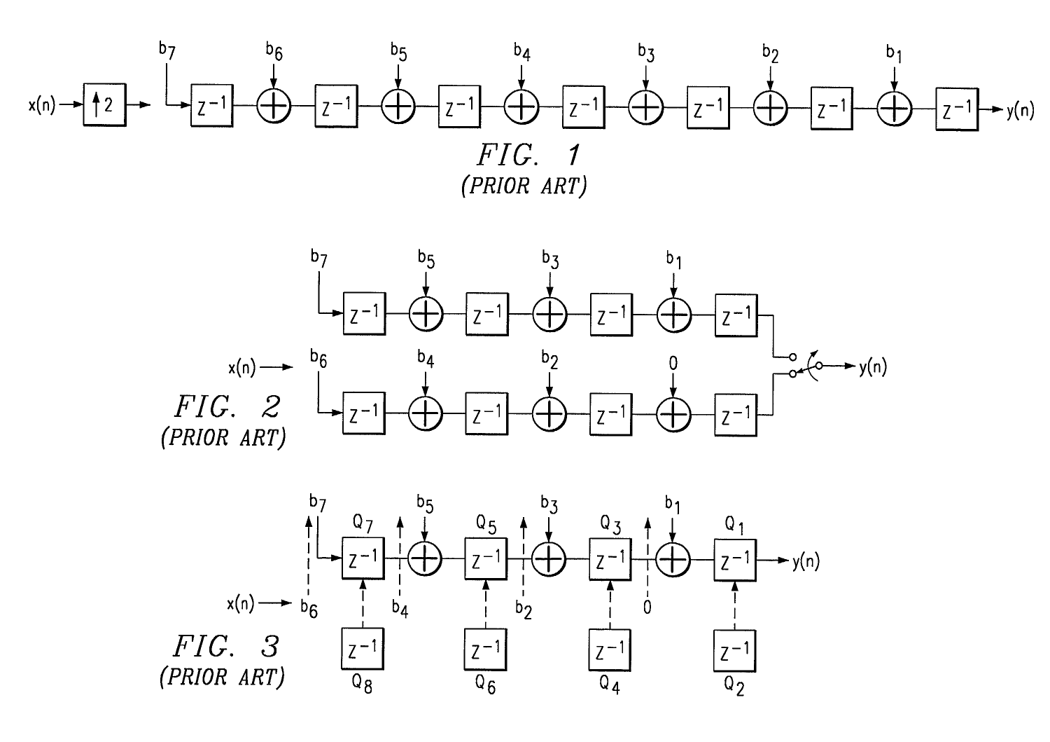

With reference first to FIG. 3, there is shown a first embodiment in accordance with the present invention. In accordance with this embodiment, adders are saved through reuse. As stated above, since an N-bit ripple adder takes about the same number of gates a does an N-bit register, reducing the number of adders can also reduce the silicon area of the semiconductor chip required for the components quite significantly. Since the second set of delay elements of FIG. 2 is identical in structure to the first set of delay elements, the reuse of adders in the first set of delay elements can be effectuated. To this end, the filter is operated at twice the clock rate of clk. In the first half of the clk period, the output of the first set of delay elements Q₇, Q₅, Q₃ and Q₁ is calculated and in the second half of the clk period, the output of the second set of delay elements Q₈, Q₆, Q₄ and Q₂ is calculated as shown in FIG. 3. The output y(n) is the output of the last register in the first set of delay elements with no output multiplexer required. The adders of the first set of delay elements are reused by running the filter at twice the clock rate and computing H₀(z) and H₁(z) on a time-sharing basis using only the adders shown as coupled to the delay elements Q₇, Q₅, Q₃ and Q₁ on a multiplexed basis.

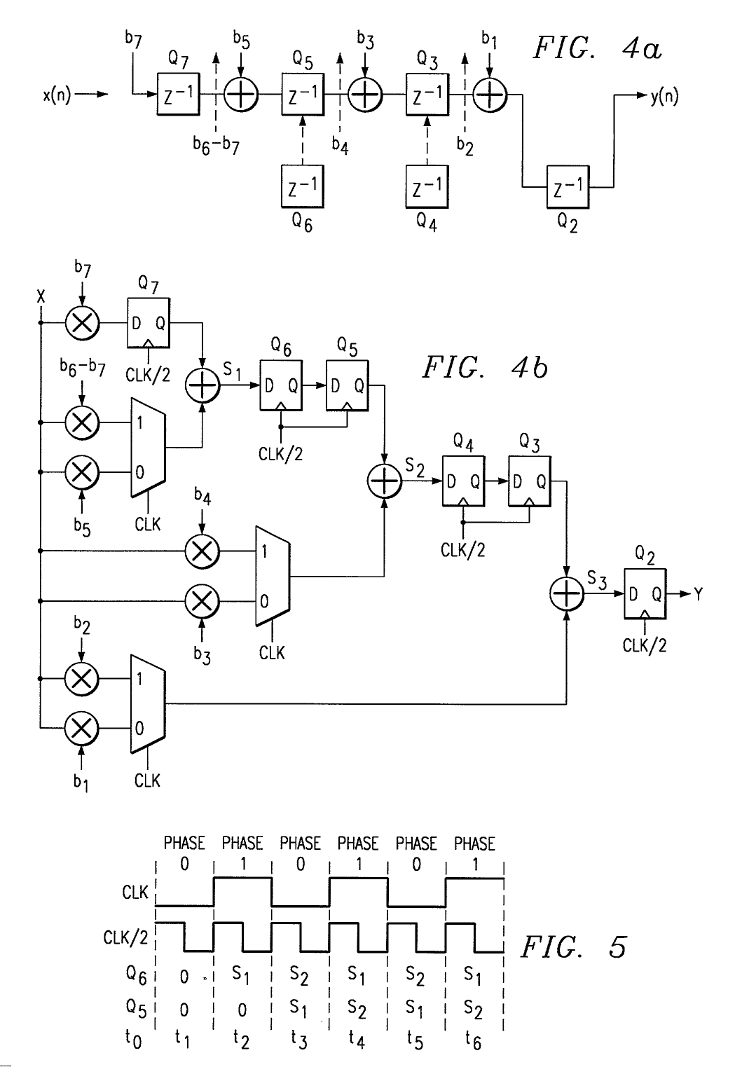

The system of FIG. 3 can be further optimized to omit two redundant registers. In this regard, delay elements Q₁ and Q₂ can be shared, thereby removing delay element Q₂. Also delay element Q₈ can be shared with delay element Q₇, thereby removing delay element Q₇. Since delay element Q₇ stores b₇x in the first clock phase, it has to be adjusted by subtracting b₇x in order to obtain the correct value in the second clock phase. This system is shown in FIG. 4. Multiplication of x by bᵢ is actually performed by shifts and addition of x.

The example as set forth in FIG. 4 is an interpolation filter with interpolation factor of two, it being understood that the invention herein can be applied to a decimation filter as well. A decimation filter is similar to an interpolation filter in its implementation except that, with reference to FIG. 2, the multiplex output turns into the input multiplexer in the front for the decimation filter. This invention can also be applied to filters with interpolation/decimation factor other than two, the number two being used herein only by way of example.

The silicon area saved by the present invention for an Lth order filter with decimation factor M can be estimated. The major hardware for the filter is assumed to be the adders and the registers. It is also assumed that an N-bit adder has the same gate count as an N-bit register. The total number of registers required is NL, and the adders equivalently occupy NL register areas. Therefore, the total number of areas required for the system of FIG. 1 is 2 NL. In contrast, there are only N/M adders in the system of FIG. 4b, therefore the total number of areas required is (1+1/M)NL for the system of FIG. 4b. For the foregoing example, with M=2, the required chip area is reduced by 25 percent by this estimation. Greater chip area reduction can be achieved with a higher interpolation/decimation factor M. A 7th order filter with M=2 can be synthesized with a 24 percent reduction in gate count. There are slightly more gates required than the estimation, mainly due to the small number of multiplexers required for the coefficients as shown in FIG. 4b.

With reference to FIG. 4b, the input x is applied to each of a first multiplier where it is multiplied by the coefficient b₇, a second multiplier where input x is multiplied by result of coefficients b₇−b₆, a third multiplier where input x is multiplied by coefficient b₅, a fourth multiplier where input x is multiplied by coefficient b₄, a fifth multiplier where input x is multiplied by coefficient b₃, a sixth multiplier where input x is multiplied by a coefficient b₂ and a seventh multiplier where input x is multiplied by a coefficient b₁. The b₇ product is delayed by D flip-flop Q₇, which is clocked at a clock rate of clk/2 and supplied to a first adder. The b₆−b₇ product and the b₅ product are multiplexd by the clock clk, the output of which is added to the output of flip flop Q₇ in the first adder to provide an output S₁. This output is delayed in D flip flops Q₆ and Q₅ which are also clocked at the clock rate clk/2 with the output applied to a second adder. The b₄ product and b₃ product are multiplexd by the clk, the output of which is applied to the second adder. The sum of the two signal applied to the second adder is the output S₂ which is applied to D flip-flops Q₄ and Q₃ which are also clocked at a clock rate of clk/2 with the output of these flip-flops being applied to a third adder. The b₂ and b₁ products are multiplexed by the clk, the output of which is also applied to the third adder and added to provide the output S₃. This output is delayed by D flip-flop Q2 which is clocked at the clock rate clk/2 to provide the output y. The timing diagram for the circuit of FIG. 4b is shown in FIG. 5 where all registers are clocked by clk/2 while all multiplexers are controlled by clk which operates at one half the speed of clk/2. The following equations are true for the embodiment of FIG. 5:

At phase 0:

S1(i)=b₇x(i)+(b₆−b₇)x(i)=b₆x(i)

S2(i)=S1(i−2)+b₄x(i)=b₆x(i=2)+b₄x(i)

S3(i)=S2(i−2)+b₂x(i)=b₆x(i−4(+b₄x(i−2)+b₂x(i)

At phase 1:

S1(i)=b₇x(i−2)+b₅x(i)

S2(i)=S1(i−2)+b₃x(i)=b₇x(i−4)+b₅x(i−2)+b₃x(i)

S3(i)=S2(i−2)+b₁x(i)=b₇x(i−6)+b₅x(i−4)+b₃x(i−2)+b₁x(i)

where i is the time index and i-n means n time clocks later. In phase 0, the result of the upper half branch in FIG. 4b is obtained and in phase 1 the result of the lower half branch in FIG. 4b is obtained.

It can be seen that the function of the circuit of FIG. 2 is provided in FIGS. 4 and 5 without four of the adders, two of the flip-flops and without the multiplexer. Accordingly, a significant amount of chip area is saved for other uses.

Though the invention has been described with reference to a specific preferred embodiment thereof, many variations and modifications will immediately become apparent to those skilled in the art. It is therefore the intention that the appended claims be interpreted as broadly as possible in view of the prior art to include all such variations and modifications.

1. A digital filter which comprises:
a first plurality of delay components connectable in series and having an input and an output;
a second plurality of delay components connectable in series and having an input and said output;
a system input coupled to each of said inputs of said first and second pluralities of delay components; and
a plurality of adders, each adder couplable alternately to a different delay component of said first plurality of delay components and then to a different delay component of said second plurality of delay components.

2. The digital filter of claim 1 wherein the number of delay components of said second plurality of delay components is equal in number to said first plurality of delay components.

3. The digital filter of claim 1 wherein said input is concurrently coupled to each of said inputs of said first and second pluralities of delay components.

4. The digital filter of claim 2 wherein said input is concurrently coupled to each of said inputs of said first and second pluralities of delay components.

5. The digital filter of claim 1 wherein the number of adders is equal to one less than the number of delay components in said first or second pluralities of delay components.

6. The digital filter of claim 2 wherein the number of adders is equal to one less than the number of delay components in said first or second pluralities of delay components.

7. The digital filter of claim 3 wherein the number of adders is equal to one less than the number of delay components in said first or second pluralities of delay components.

8. The digital filter of claim 4 wherein the number of adders is equal to one less than the number of delay components in said first or second pluralities of delay components.

9. The digital filter of claim 1 wherein said wherein said digital filter is a FIR filter.

10. The digital filter of claim 8 wherein said wherein said digital filter is a FIR filter.

11. The digital filter of claim 1 wherein the number of adder is equal to the number of delay components in said first or second pluralities of delay components.

12. The digital filter of claim 2 wherein the number of adder is equal to the number of delay components in said first or second pluralities of delay components.

13. The digital filter of claim 3 wherein the number of adder is equal to the number of delay components in said first or second pluralities of delay components.

14. The digital filter of claim 4 wherein the number of adder is equal to the number of delay components in said first or second pluralities of delay components.

15. The digital filter of claim 11 wherein said wherein said digital filter is a FIR filter.

16. The digital filter of claim 14 wherein said wherein said digital filter is a FIR filter.
